(19) United States
(12) Patent Application Publication
(10) Pub. No.: US 2021/0003418 A1
(43) Pub. Date: Jan. 7, 2021

(54) ROBOT MANAGEMENT SYSTEM, ROBOT MANAGEMENT METHOD, INFORMATION PROCESSING APPARATUS, INFORMATION PROCESSING METHOD, AND INFORMATION PROCESSING PROGRAM

(71) Applicant: NEC Corporation, Tokyo (JP)

(72) Inventors: Kanako HATAYAMA, Tokyo (JP); Dai KINNO, Tokyo (JP); Emi FUKUDOME, Tokyo (JP)

(73) Assignee: NEC Corporation, Tokyo (JP)

(21) Appl. No.: 16/978,266

(22) PCT Filed: Feb. 15, 2019
(86) PCT No.: PCT/JP2019/005649

§ 371 Date: Sep. 4, 2020

(30) Foreign Application Priority Data
Mar. 5, 2018 (JP) 2018-039055

(51) Int. Cl. G01C 21/00; G05D 1/02

(52) U.S. Cl. CPC G01C 21/3841; G05D 1/0214; G05D 2201/0203; G05D 1/0287; G05D 1/0274

(57) ABSTRACT

This invention provides an information processing apparatus for efficiently controlling multiple types of robots that move based on map data in different formats. This information processing apparatus includes an acquirer that acquires map data generated by at least one of the multiple types of robots that move based on map data in different formats indicating movable areas, respectively, a common map generator that generates, from the acquired map data, a common map for commonly managing movements of the multiple types of robots, and a specific map generator that generates, from the generated common map, multiple types of specific maps to be respectively used by the multiple types of robots.

### CROSS REFERENCE TO RELATED APPLICATIONS

This application is based upon and claims the benefit of priority from Japanese patent application No. 2018-039055, filed on Mar. 5, 2018, the disclosure of which is incorporated herein in its entirety by reference.

### TECHNICAL FIELD

The present invention relates to a robot management system, a robot management method, an information processing apparatus, an information processing method, and an information processing program.

### BACKGROUND ART

In the above technical field, patent literature 1 discloses a technique of performing conversion between the coordinate system of a local map around each mobile terminal generated by each of identical terminal apparatuses carried by a plurality of persons and the coordinate system of a global map of the entire space. Then, the local maps generated by the terminal apparatuses can also be shared.

### CITATION LIST

### Patent Literature

Patent literature 1: Japanese Patent No. 5471626

### SUMMARY OF THE INVENTION

### Technical Problem

Since, however, the technique described in the above patent literature performs conversion of the coordinate system in the identical terminal apparatuses, it is impossible to apply the technique to a technique of efficiently controlling multiple types of robots that move based on map data in different formats.

The present invention provides a technique of solving the above-described problem.

### Solution to Problem

One example aspect of the present invention provides an information processing apparatus comprising:

an acquirer that acquires map data generated by at least one of multiple types of robots that move based on map data in different formats indicating movable areas, respectively;

a common map generator that generates, from the acquired map data, a common map for commonly managing movements of the multiple types of robots; and

a specific map generator that generates, from the generated common map, multiple types of specific maps to be respectively used by the multiple types of robots.

Another example aspect of the present invention provides an information processing program for causing a computer to execute a method, comprising:

acquiring map data generated by at least one of multiple types of robots that move based on map data in different formats indicating movable areas, respectively;

generating, from the acquired map data, a common map for commonly managing movements of the multiple types of robots; and

generating, from the generated common map, multiple types of specific maps to be respectively used by the multiple types of robots.

Still other example aspect of the present invention provides an information processing program for causing a computer to execute a method, comprising:

acquiring map data generated by at least one of multiple types of robots that move based on map data in different formats indicating movable areas, respectively;

generating, from the acquired map data, a common map for commonly managing movements of the multiple types of robots; and

generating, from the generated common map, multiple types of specific maps to be respectively used by the multiple types of robots.

Still other example aspect of the present invention provides a robot management system comprising:

multiple types of robots;

an acquirer that acquires map data generated by at least one of the multiple types of robots that move based on map data in different formats indicating movable areas, respectively;

a common map generator that generates, from the acquired map data, a common map for commonly managing movements of the multiple types of robots;

a specific map generator that generates, from the generated common map, multiple types of specific maps to be respectively used by the multiple types of robots, respectively; and

a movement instructor that sends movement instructions to the multiple types of robots by converting, using conversion information for converting a position on the generated common map into positions on the multiple specific maps, movement target positions of the multiple types of robots on the generated common map into movement target positions of the multiple types of robots on the multiple types of specific maps, respectively.

Still other example aspect of the present invention provides a robot management method comprising:

acquiring map data generated by at least one of multiple types of robots that move based on map data in different formats indicating movable areas, respectively;

generating, from the acquired map data, a common map for commonly managing movements of the multiple types of robots;

generating, from the generated common map, multiple types of specific maps to be respectively used by the multiple types of robots; and

sending movement instructions to the multiple types of robots by converting, using conversion information for converting a position on the generated common map into positions on the multiple types of specific map, movement target positions of the multiple types of robots on the generated common map into movement target positions of the multiple types of robots on the multiple types of specific maps, respectively.

### Advantageous Effects of Invention

According to the present invention, it is possible to efficiently control multiple types of robots that move based on map data in different formats.

### BRIEF DESCRIPTION OF DRAWINGS

FIG. 1 is a block diagram showing the arrangement of an information processing apparatus according to the first example embodiment of the present invention;

FIG. 2A is a view showing an overview of a robot management system including an information processing apparatus according to the second example embodiment of the present invention;

FIG. 2B is a view showing another overview of the robot management system including the information processing apparatus according to the second example embodiment of the present invention;

FIG. 2C is a view showing Application 1 of the robot management system including the information processing apparatus according to the second example embodiment of the present invention;

FIG. 2D is a view showing Application 2 of the robot management system including the information processing apparatus according to the second example embodiment of the present invention;

FIG. 2E is a view showing Application 3 of the robot management system including the information processing apparatus according to the second example embodiment of the present invention;

FIG. 2F is a view showing Application 4 of the robot management system including the information processing apparatus according to the second example embodiment of the present invention;

FIG. 2G is a view showing Application 5 of the robot management system including the information processing apparatus according to the second example embodiment of the present invention;

FIG. 2H is a view showing Application 6 of the robot management system including the information processing apparatus according to the second example embodiment of the present invention;

FIG. 3 is a sequence chart showing the operation procedure of the robot management system including the information processing apparatus according to the second example embodiment of the present invention;

FIG. 4 is a block diagram showing the functional arrangement of the information processing apparatus according to the second example embodiment of the present invention;

FIG. 5 is a table showing the structure of a robot database according to the second example embodiment of the present invention;

FIG. 6 is a table showing the structure of a common map generation table according to the second example embodiment of the present invention;

FIG. 7 is a table showing the structure of a common map database according to the second example embodiment of the present invention;

FIG. 8 is a table showing the structure of a specific map generation table according to the second example embodiment of the present invention;

FIG. 9 is a block diagram showing the hardware arrangement of the information processing apparatus according to the second example embodiment of the present invention;

FIG. 10 is a flowchart illustrating the processing procedure of the information processing apparatus according to the second example embodiment of the present invention;

FIG. 11A is a flowchart illustrating the procedure of common map generation processing according to the second example embodiment of the present invention;

FIG. 11B is a flowchart illustrating the procedure of specific map generation processing according to the second example embodiment of the present invention;

FIG. 12 is a view showing an overview of a robot management system including an information processing apparatus according to the third example embodiment of the present invention;

FIG. 13 is a sequence chart showing the operation procedure of the robot management system including the information processing apparatus according to the third example embodiment of the present invention;

FIG. 14 is a block diagram showing the functional arrangement of the information processing apparatus according to the third example embodiment of the present invention;

FIG. 15 is a flowchart illustrating the processing procedure of the information processing apparatus according to the third example embodiment of the present invention;

FIG. 16 is a flowchart illustrating the procedure of common map update processing according to the third example embodiment of the present invention;

FIG. 17 is a view showing an overview of a robot management system including an information processing apparatus according to the fourth example embodiment of the present invention; and

FIG. 18 is a view showing an overview of a robot management system including an information processing apparatus according to the fifth example embodiment of the present invention.

### DESCRIPTION OF EXAMPLE EMBODIMENTS

Example embodiments of the present invention will now be described in detail with reference to the drawings. It should be noted that the relative arrangement of the components, the numerical expressions and numerical values set forth in these example embodiments do not limit the scope of the present invention unless it is specifically stated otherwise. Note that in this specification, a term “robot” is a concept including a drone as a moving apparatus.

### First Example Embodiment

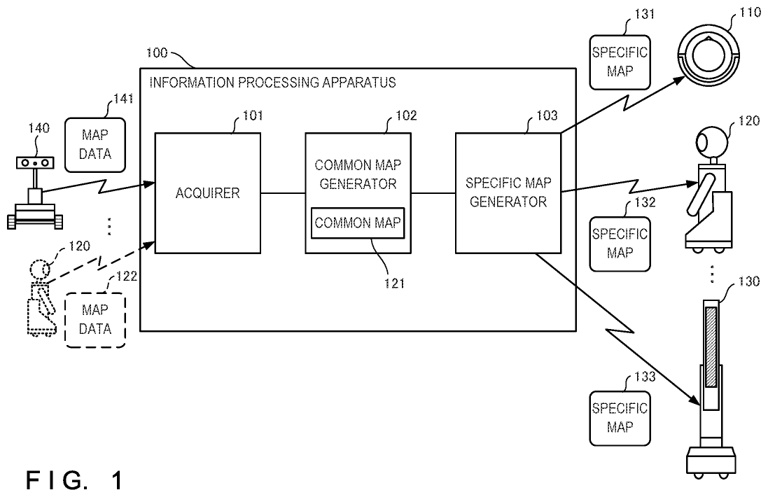

An information processing apparatus 100 according to the first example embodiment of the present invention will be described with reference to FIG. 1. The information processing apparatus 100 is an apparatus that controls the movement of a robot.

As shown in FIG. 1, the information processing apparatus 100 comprises an acquirer 101, a common map generator 102, and a specific map generator 103. The acquirer 101 acquires map data 141 (122) generated by at least one robot 140 (120) among the multiple types of robots 120 and 140 that move based on map data in different formats indicating movable areas. The common map generator 102 generates, from the acquired map data 141 (122), a common map 121 for commonly managing the movements of multiple types of robots 110 to 130. The specific map generator 103 generates, from the common map 121, multiple types of specific maps 131 to 133 to be respectively used by the multiple types of robots 110 to 130. Note that the acquirer 101 may be formed as a receiver that receives map data from the robot or formed by another method, for example, an arbitrary arrangement of loading map data from a storage medium.

According to this example embodiment, it is possible to control, by one common map, multiple types of robots that move based on map data in different formats indicating movable areas, thereby efficiently controlling the multiple types of robots.

### Second Example Embodiment

A robot management system including an information processing apparatus according to the second example embodiment of the present invention will be described next. In the robot management system including the information processing apparatus according to this example embodiment, a common map is generated by collecting and integrating map data of different formats generated by multiple types of autonomous mobile robots that move based on map data of different formats indicating movable areas. Then, a specific map to be used by each autonomous mobile robot is generated from the common map, and distributed to each autonomous mobile robot, thereby managing the movement of each autonomous mobile robot. Note that in the following example embodiment, generation of a common map and generation of a specific map corresponding to each robot will be described by exemplifying autonomous mobile robots which can obtain a remarkable effect. The present invention, however, is not limited to this.

In the following example embodiment, “the attribute of a robot” includes a generation map attribute, held for each robot, for generating map data, and a use map attribute for generating a specific map from a common map. Furthermore, “the attribute of a common map” includes the attribute of each element forming the common map, for example, the obstacle attribute of an obstacle. A “robot moving ability” indicates whether the robot can overcome the obstacle conditions of various obstacles, and includes moving energy and a moving speed. “Obstacle movability” includes an immovability attribute for a column, a shelf, a wall, or the like, and a movability attribute for a table, a door, or the like. Note that the movability attribute includes a temporary movability attribute and an always movability attribute.

<<Robot Management System>>

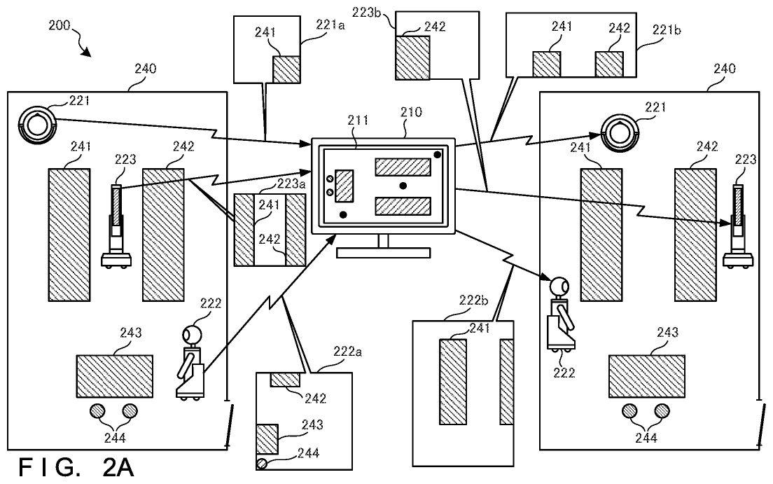

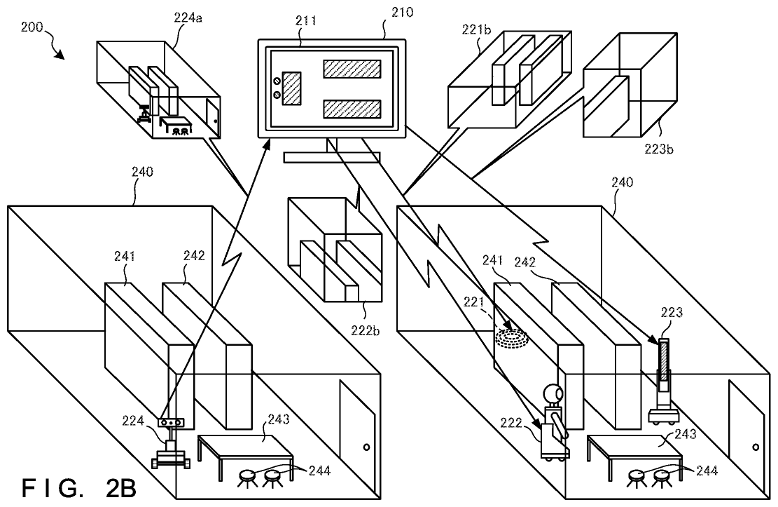

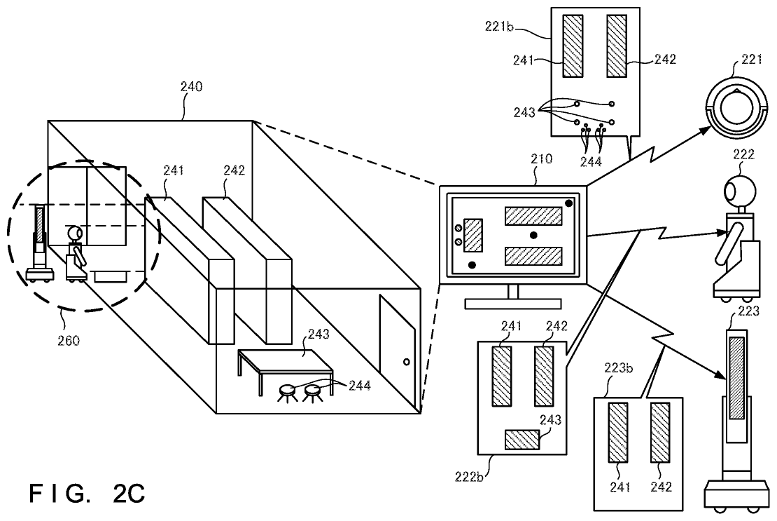

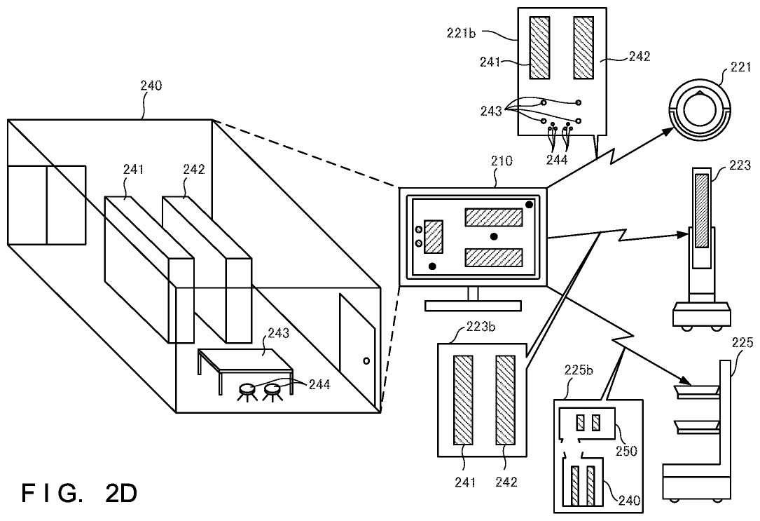

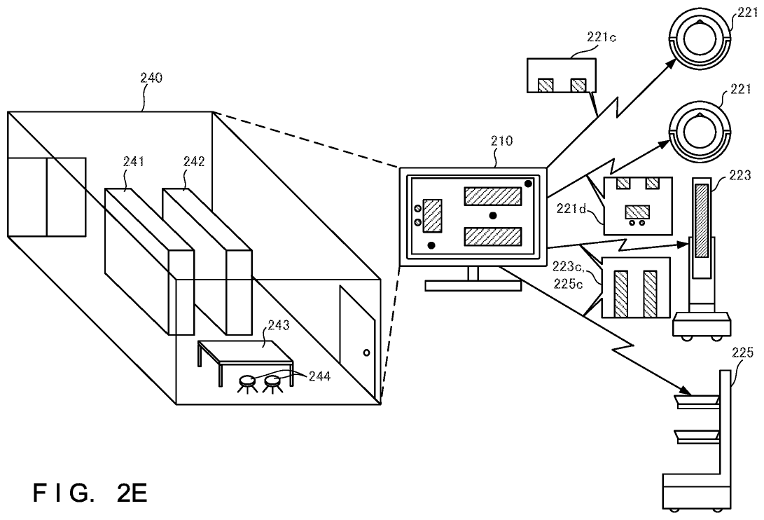

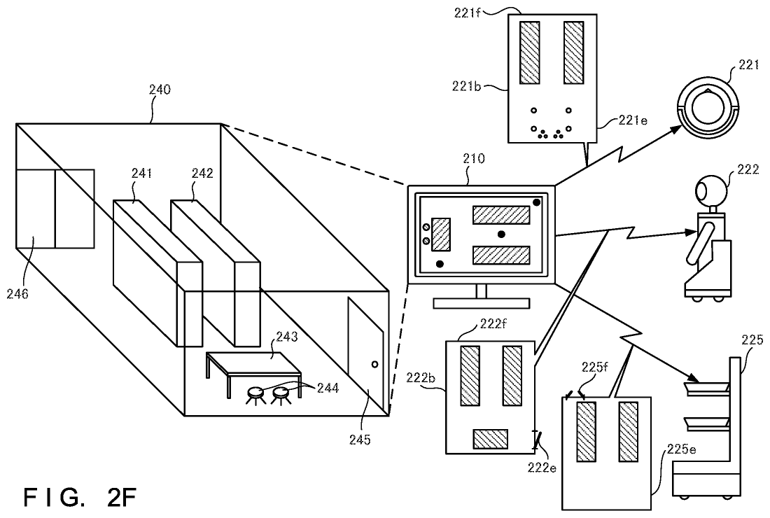

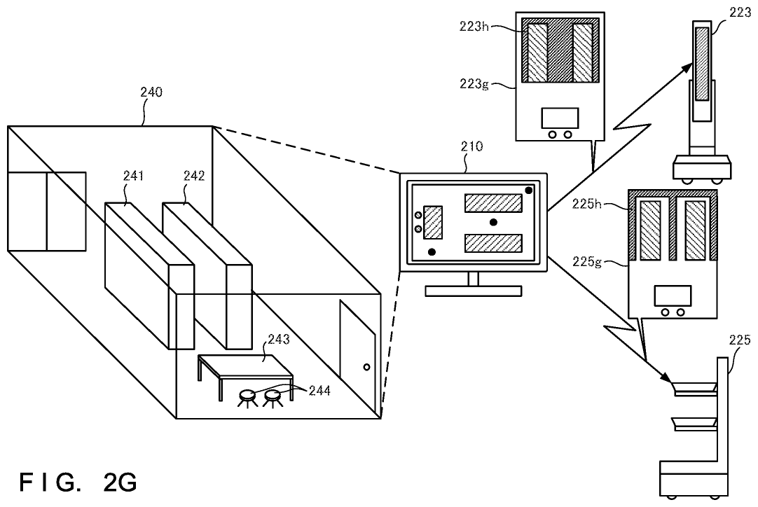

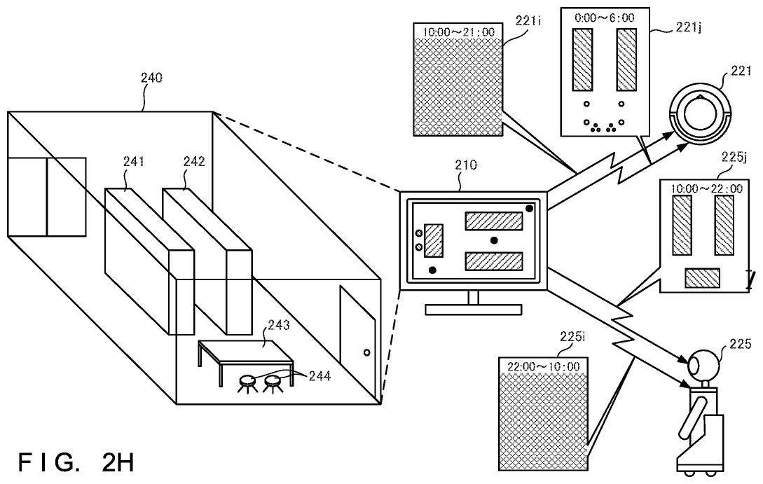

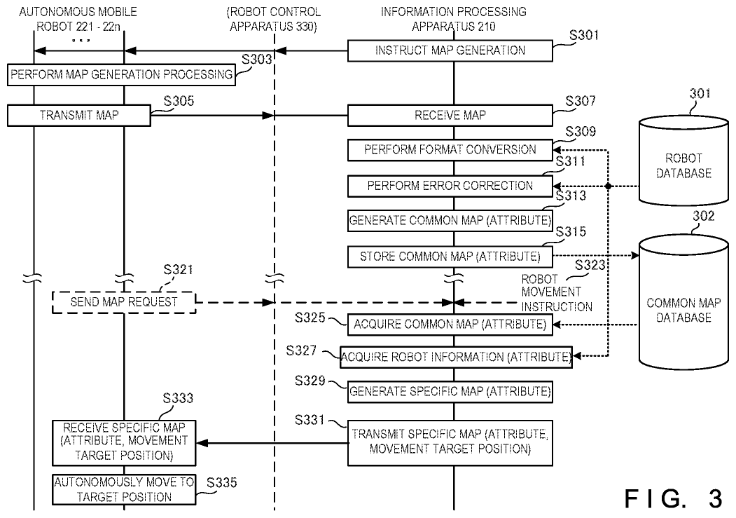

The arrangement and operation of a robot management system 200 including an information processing apparatus 210 according to this example embodiment will be described with reference to FIGS. 2A to 3.

(Overview)

FIG. 2A is a view showing an overview of the robot management system 200 including the information processing apparatus 210 according to this example embodiment. FIG. 2A is a view showing an example of a two-dimensional map.

Although, for example, the internal area of a store 240 can be set as the movable area of a robot, two store shelves 241 and 242, a customer table 243, and chairs 244 are arranged in the store 240. The two store shelves 241 and 242 are static obstacles that cannot be moved, the customer table 243 is a semi-static obstacle that can be moved but is not moved so often, and the chairs are moving obstacles that can always be moved. Assume that a cleaning robot 221, a guide robot 222, and a shelf product distribution robot 223 are working in the store 240 as multiple types of robots that move based on map data of different formats.

The information processing apparatus 210 receives map data from the cleaning robot 221, the guide robot 222, and the shelf product distribution robot 223, generates a common map from the received map data, and displays the common map on a display screen 211. On the display screen 211, the position of each robot is displayed as a solid circle.

The cleaning robot 221 transmits map data 221a at the height of a floor to the information processing apparatus 210. The map data 221a is data of a range including part of the store shelf 241. The guide robot 222 transmits map data 222a at a height of about 1 m from the floor to the information processing apparatus 210. The map data 222a is data of a range including part of the store shelf 242 and parts of the customer table 243 and the chair. The shelf product distribution robot 223 transmits map data 223a at the height of the upper portion of the shelf to the information processing apparatus 210. The map data 223a is data of a range including the facing surface sides of the store shelves 241 and 242.

The information processing apparatus 210 receives these map data 221a to 223a, and generates a common map for commonly managing the movements of the multiple types of robots. If the map data 221a to 223a are not enough as information for generating the common map of the whole store 240, the common map may be generated by collecting a map generated in other areas or a map generated by other robots, converting the formats into a common format, and performing error correction. At this time, the information processing apparatus 210 holds, for each robot, conversion information (conversion parameters) between each map data and the common map in a holder.

Specific Maps for the respective robots generated from the common map by the information processing apparatus 210 are distributed to the cleaning robot 221, the guide robot 222, and the shelf product distribution robot 223.

The information processing apparatus 210 generates the specific maps in consideration of the current positions of the respective robots and the attributes of the robots, and distributes the specific maps to the respective robots. At the same time, the information processing apparatus 210 distributes a movement instruction if a movement request of the robot is issued.

The information processing apparatus 210 transmits a specific map 221b of a moving range at the height of the floor to the cleaning robot 221. The specific map 221b is a map of a range including parts of the store shelves 241 and 242, which is obtained in consideration of the current position of the cleaning robot 221 by also generating, from the common map, an area not included in the map data 221a generated by the self apparatus. The information processing apparatus 210 transmits a specific map 222b of a moving range at a height of about 1 m from the floor to the guide robot 222. The specific map 222b is a map of a range including the store shelf 241 and part of the store shelf 242, which is obtained in consideration of the current position of the guide robot 222 by also generating, from the common map, an area not included in the map data 222a generated by the self apparatus. The information processing apparatus 210 transmits a specific map 223b of a moving range at the height of the upper portion of the shelf to the shelf product distribution robot 223. The specific map 223b is a map of a range including part of the store shelf 242 on the wall side, which is obtained in consideration of the current position of the shelf product distribution robot 223 by also generating, from the common map, an area not included in the map data 223a generated by the self apparatus.

As shown in FIG. 2A, the information processing apparatus 210 collects the map data respectively generated within the detectable ranges of the cleaning robot 221, the guide robot 222, and the shelf product distribution robot 223, thereby generating a common map. The information processing apparatus 210 generates specific maps corresponding to the current positions and attributes of the respective robots based on the common map, and distributes the specific maps to the respective robots. Therefore, it is possible to efficiently control the multiple types of robots that move based on the map data of the different formats.

FIG. 2B is a view showing another overview of the robot management system 200 including the information processing apparatus 210 according to this example embodiment. An example of a three-dimensional map will be described with reference to FIG. 2B. Note that the store 240 is the same, and the internal arrangement of the store 240 is also the same. In FIG. 2B, the same reference numerals as in FIG. 2A denote similar components.

Referring to FIG. 2B, a map generation-only robot 224 capable of generating a three-dimensional map generates three-dimensional map data 224a of the whole store 240, and transmits it to the information processing apparatus 210. The information processing apparatus 210 generates a common map from the three-dimensional map data 224a, and displays it on the display screen 211.

Then, the specific maps 221b to 223b to be distributed to the respective robots are generated by selecting areas from the common map based on the current positions and moving ranges of the robots, and converting the formats based on the attributes of the robots, respectively.

As shown in FIG. 2B, if the common map is a three-dimensional map, specific maps more adaptive to the respective robots are applicable.

(Application 1: Slicing of Common Map According to Height of Robot)

FIG. 2C is a view showing Application 1 of the robot management system 200 including the information processing apparatus 210 according to this example embodiment. Note that in FIG. 2C, the same reference numerals as in FIG. 2B denote similar components and a repetitive description thereof will be omitted.

Referring to FIG. 2C, the common map is a three-dimensional map including information in a height direction. Then, as shown in a portion surrounded by a thick broken line 260, the three types of robots are different in size (height) in the vertical direction. The information processing apparatus 210 generates specific maps by slicing the common map at the heights corresponding to the sizes in the vertical direction of the three types of robots, and distributes the specific maps. Note that each specific map generated by slicing may be two- or three-dimensional map.

For example, in the specific map 221b distributed to the cleaning robot 221, only legs are shown as obstacles in the customer table 243 and the chairs 244. In the specific map 222b distributed to the guide robot 222, the customer table 243 is an obstacle but the chairs 244 are not obstacles. In the specific map 223b distributed to the shelf product distribution robot 223, the store shelves 241 and 242 are obstacles but the customer table 243 and the chairs 244 are not obstacles.

As described above, it is possible to reduce the distribution information and reduce the load of the moving processing of each robot by selecting necessary information from the common map in accordance with the size in the vertical direction of each robot and generating the specific map.

(Application 2: Generation of Specific Map According to Role of Robot)

FIG. 2D is a view showing Application 2 of the robot management system 200 including the information processing apparatus 210 according to this example embodiment. Note that in FIG. 2D, the same reference numerals as in FIGS. 2B and 2C denote similar components and a repetitive description thereof will be omitted. Processing according to this example embodiment will be described by adding, in FIG. 2D, a product conveying robot 225 whose role is clear and whose moving range is special.

Since the cleaning robot 221 plays a role in cleaning, if an instruction is issued without limiting the moving range, the cleaning robot 221 moves in the entire area of the store 240. The shelf product distribution robot 223 plays a role in distributing products to the shelves, and the moving range of the shelf product distribution robot 223 is limited to the periphery of the store shelves 241 and 242. Note that if the facing surfaces of the store shelves 241 and 242 are set as the target range of the shelf product distribution robot 223, the moving range may be limited more. The product conveying robot 225 plays a role in conveying products from a stockroom or back room 250 to the store shelves 241 and 242, and the moving range of the product conveying robot 225 is limited to an area between the stockroom or back room 250 and the store shelves 241 and 242.

As a result, as the specific map distributed to each robot by the information processing apparatus 210, the specific map 221b of the whole store 240 is distributed to the cleaning robot 221. The specific map 222b of only the periphery of the store shelves 241 and 242 is distributed to the shelf product distribution robot 223. A specific map 225b of only the area between the stockroom or back room 250 and the store shelves 241 and 242 is distributed to the product conveying robot 225. Furthermore, with respect to the product conveying robot 225, an exclusive passage may be included in the specific map 225b.

As described above, it is possible to reduce the distribution information and reduce the load of the moving processing of each robot by selecting the area of the moving range from the common map in accordance with the role of each robot and generating the specific map.

(Application 3: Generation of Specific Map According to Moving Range of Robot)

FIG. 2E is a view showing Application 3 of the robot management system 200 including the information processing apparatus 210 according to this example embodiment. Note that in FIG. 2E, the same reference numerals as in FIGS. 2B to 2D denote similar components and a repetitive description thereof will be omitted.

If the cleaning robot 221 has a deep portion in the store shelves as a cleaning range, a specific map 221c transmitted from the information processing apparatus 210 to the cleaning robot 221 includes only the deep portion in the store shelves. If the cleaning robot 221 has, as a cleaning range, an area including the customer table 243, a specific map 221d transmitted from the information processing apparatus 210 to the cleaning robot 221 includes only the area including the customer table 243. The moving range of each of the shelf product distribution robot 223 and the product conveying robot 225 is not the area including the customer table 243 but the periphery of the store shelves. Therefore, each of a specific map 223c transmitted from the information processing apparatus 210 to the shelf product distribution robot 223 and a specific map 225c transmitted from the information processing apparatus 210 to the product conveying robot 225 includes only the periphery of the store shelves except for the area including the customer table 243.

As described above, it is possible to reduce the distribution information and reduce the load of the moving processing of each robot by selecting the area of the moving range from the common map in accordance with the moving range of each robot and generating the specific map.

(Application 4: Generation of Specific Map by Changing Attribute of Obstacle According to Robot)

FIG. 2F is a view showing Application 4 of the robot management system 200 including the information processing apparatus 210 according to this example embodiment. Note that in FIG. 2F, the same reference numerals as in FIGS. 2B and 2E denote similar components and a repetitive description thereof will be omitted.

Referring to FIG. 2F, the common map includes a plurality of obstacles of different attributes. The information processing apparatus 210 generates specific maps from the common map in consideration of the attributes of the obstacles. In FIG. 2F, assume that a door 245 at the entrance of the store 240 and a door 246 to the stockroom or back room 250 are obstacles each with an attribute of “door”.

Since the cleaning robot 221 need not go out of the store 240, the attribute of an obstacle 221e representing the door 245 and that of an obstacle 221f representing the door 246 are changed to “wall” in the specific map 221b distributed from the information processing apparatus 210 to the cleaning robot 221. Since the door 245 is the entrance for customers in the store 240, the guide robot 222 needs to recognize the door 245. Thus, the attribute of an obstacle 222e representing the door 245 remains “door”, and the attribute of an obstacle 222f representing the door 246 is changed to “wall”. Furthermore, since the product conveying robot 225 uses not the door 245 but the door 246, the attribute of the obstacle 222e representing the door 245 is changed to “wall”, and the attribute of the obstacle 222f representing the door 246 remains “door”.

Assume also that the floor of the portion of the door 245 has an attribute of “flat” and the floor of the door 246 has an attribute of “step”. In this case, in consideration of the moving ability of each robot, in this example, in consideration of whether each robot has an ability of climbing over the step, a specific map is generated by setting the step as a static obstacle when the moving ability is low. In addition, if the moving ability is low, the robot cannot climb a slope or the like on the floor, and thus a specific map is generated by setting the slope as a static obstacle.

As described above, it is possible to reduce the load of each robot by changing the attribute of each element included in the common map to another attribute in consideration of the attribute or moving ability of the robot to reduce the number of times of determination at the time of movement of the robot.

(Application 5: Generation of Specific Map by Setting Moving Range According to Robot)

FIG. 2G is a view showing Application 5 of the robot management system 200 including the information processing apparatus 210 according to this example embodiment. Note that in FIG. 2G, the same reference numerals as in FIGS. 2B and 2F denote similar components and a repetitive description thereof will be omitted.

In FIG. 2G, an attribute is added to each region of the common map. For example, an attribute indicating shelf product distribution is added to the periphery of the store shelves. Since the shelf product distribution robot 223 operates for shelf product distribution, the information processing apparatus 210 generates a specific map 223g including only a periphery 223h of the store shelves, and distributes it to the shelf product distribution robot 223. Furthermore, an attribute indicating product conveyance is added to a portion along the wall in the periphery of the store shelves. Since the product conveying robot 225 operates for product conveyance, the information processing apparatus 210 generates a specific map 225g including only a product conveyance region 225h, and distributes it to the product conveying robot 225.

Furthermore, in the common map, attributes of a dedicated region where the robot moves, an area where the robot should not enter, and an area where the moving speed of the robot is limited are provided, and then a specific map on which the attributes of the areas are reflected may be generated. That is, if the robot moves in one of the areas with the above attributes, the attribute is reflected on movement control.

As described above, a specific map appropriate for each robot is provided by adding the attribute to the moving range of the common map, and reflecting the attribute on generation of the specific map, thereby making it possible to efficiently control the multiple types of robots.

(Application 6: Generation of Different Specific Map According to Time Period)

FIG. 2H is a view showing Application 6 of the robot management system 200 including the information processing apparatus 210 according to this example embodiment. Note that in FIG. 2H, the same reference numerals as in FIGS. 2B and 2G denote similar components and a repetitive description thereof will be omitted.

A simple example will be described with reference to FIG. 2H. The information processing apparatus 210 distributes a specific map 221i to the cleaning robot 221 during a time period (10:00 to 21:00) when the store 240 is congested. In the specific map 221i, the whole store 240 is represented as a static obstacle, and the cleaning robot 221 cannot enter the store 240. On the other hand, the information processing apparatus 210 distributes a specific map 221j to the cleaning robot 221 during a time period (0:00 to 6:00) when the congestion of the store 240 is reduced. The specific map 221j is a map corresponding to the common map, and the cleaning robot 221 can clean the inside of the store 240.

Furthermore, the information processing apparatus 210 distributes a specific map 225j to the guide robot 222 during a time period (10:00 to 22:00) when it is expected that a customer who needs a guide comes to the store 240. The specific map 225j is a map corresponding to the common map, and the guide robot 222 can guide the customer in the store 240. On the other hand, the information processing apparatus 210 distributes a specific map 225i to the guide robot 222 during a time period (22:00 to 10:00) when it is expected that a customer who needs a guide does not come to the store 240. In the specific map 225i, the whole store 240 is represented as a static obstacle, and the guide robot 222 cannot enter the store 240.

Although the above example is an extreme example, it is possible to reduce the load of each robot by generating the specific map with reference to the association between the status of the store 240 and the operation of the robot and eliminating needless communication with the robot.

Furthermore, by additionally considering the attributes of the areas in the common map shown in FIG. 2G, for example, a specific map indicating only the dedicated region where the robot moves may be distributed at the time of congestion, and a specific map without the attribute of the dedicated region for movement may be distributed to shorten the moving distance during the night or the like when there is no congestion.

Note that in the above description of FIGS. 2C to 2H, a case in which an area outside the moving range of each robot is not included in a specific map has been explained. However, an attribute of an immovable static obstacle may be added to an area outside the moving range of each robot and the area may be excluded from the moving range.

(Operation Procedure)

FIG. 3 is a sequence chart showing the operation procedure of the robot management system 200 including the information processing apparatus 210 according to this example embodiment. Note that a robot control apparatus 330 shown in FIG. 3 is an apparatus for connecting autonomous mobile robots 221 to 22n and the information processing apparatus 210, and may be additionally provided or mounted on each robot depending on the types of the robots.

In step S301, the information processing apparatus 210 instructs the autonomous mobile robots 221 to 22n to perform map generation processing. Note that if one robot performs map generation processing, a map generation instruction of the entire target moving region is issued. However, if a plurality of robots perform map generation processing in cooperation with each other, the target moving region of each robot is designated. If a detailed map is required, the target moving areas of the robots may overlap each other.

In step S303, the autonomous mobile robots 221 to 22n generate maps of respective formats by respective methods. Then, in step S305, the autonomous mobile robots 221 to 22n respectively transmit the generated maps to the information processing apparatus 210. In step S307, the information processing apparatus 210 receives the maps from the autonomous mobile robots 221 to 22n.

In step S309, the information processing apparatus 210 converts the formats of the received map data into the format of a common map based on information registered in advance in a robot database 301. In step S311, the information processing apparatus 210 performs error correction of the received map data based on the information held in the robot database 301. For example, the information processing apparatus 210 corrects the map data to maps for generation of a common map by absorbing the distortions and dimensional differences of the maps received from the robots. Then, in step S313, if one robot performs map generation processing, the information processing apparatus 210 generates a common map using the map, and if the plurality of robots perform map generation processing, the information processing apparatus 210 collects the maps to generate a common map. In this case, each of obstacles and the like included in the common map has an attribute together with position information. In step S315, the information processing apparatus 210 stores and holds the generated common map in the common map database 302.

If a map request is received from one of the autonomous mobile robots 221 to 22n in step S321 or the information processing apparatus 210 issues a robot movement instruction in step S323, the following processing is performed. Note that the map request from one of the autonomous mobile robots 221 to 22n is issued particularly when it is necessary to move to an area which is not generated by the self apparatus.

In step S325, the information processing apparatus 210 acquires the common map from the common map database 302. In addition, in step S327, the information processing apparatus 210 acquires information concerning the robot from the robot database 301. Note that the common map acquired from the common map database 302 includes the attribute of each map element, and the information concerning the robot acquired from the robot database 301 includes the attribute of the robot.

In step S329, the information processing apparatus 210 generates a specific map corresponding to each robot in consideration of the common map, the robot information, and the attributes. In step S331, the information processing apparatus 210 transmits the generated specific map to the target robot. In this case, if the information processing apparatus 210 issues a robot movement instruction, data of a movement target position is included. Note that the data of the movement target position desirably undergoes conversion such as position adjustment based on the information of the target robot.

Upon receiving the specific map in step S333, the robot autonomously moves, in step S335, to the target position determined by the self apparatus or the target position instructed by the information processing apparatus 210 based on the received specific map.

<<Functional Arrangement of Information Processing Apparatus>>

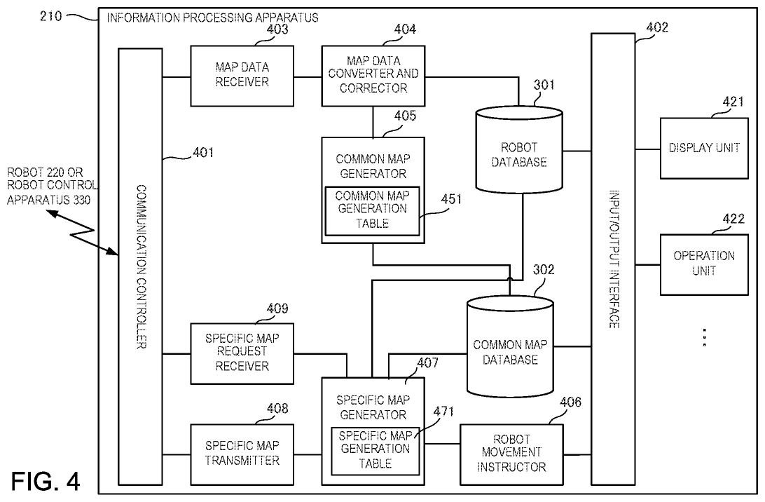

FIG. 4 is a block diagram showing the functional arrangement of the information processing apparatus 210 according to this example embodiment.

The information processing apparatus 210 includes a communication controller 401 and an input/output interface 402. The communication controller 401 controls communication with a robot 221-22n or the robot control apparatus 330. Note that the communication controller 401 can deal with a different communication protocol. A display unit 421 and an operation unit 422 are connected to the input/output interface 402. The display unit 421 is used to, for example, display a common map or monitor the position of each robot. The operation unit 422 is used to, for example, issue a common map generation instruction, a robot movement instruction, and specific map generation instruction for robot movement.

The information processing apparatus 210 also includes the robot database 301, a map data receiver 403, a map data converter and corrector 404, a common map generator 405, and a common map database 302. The robot database 301 stores the information of each robot managed and controlled by the information processing apparatus 210. The map data receiver 403 receives, from each robot, map data generated by each robot. The map data converter and corrector 404 performs conversion and correction of the received map data in accordance with the attribute of each robot registered in the robot database 301. Conversion of the map data includes format conversion into the common format of a common map, and correction of the map data includes correction of the distortion of the map unique to the robot and correction of a deviation from the common map, or adjustment of the accuracy (resolution) of the map.

The common map generator 405 includes a common map generation table 451, and generates, based on the maps having undergone format conversion and correction, a common map that can commonly manage and control all the robots. The common map database 302 stores and holds the generated common map. Note that the common map includes not only the contours of each obstacle but also additional information such as the attribute of each obstacle, and these data are also held in the common map database 302.

In addition, the information processing apparatus 210 includes a robot movement instructor 406, a specific map generator 407, a specific map transmitter 408, and a specific map request receiver 409. The robot movement instructor 406 issues a movement instruction command to the robot when a robot movement instruction is input from the operation unit 422 or the information processing apparatus 210 determines robot movement. The specific map generator 407 includes a specific map generation table 471, and generates a specific map suitable to each robot with reference to the common map and its attribute read out from the common map database 302, the attribute of the robot read out from the robot database 301, and the like. The specific map transmitter 408 transmits the generated specific map to the target robot. The specific map request receiver 409 receives a specific map request from the robot, and activates generation of a specific map by the specific map generator 407.

(Robot Database)

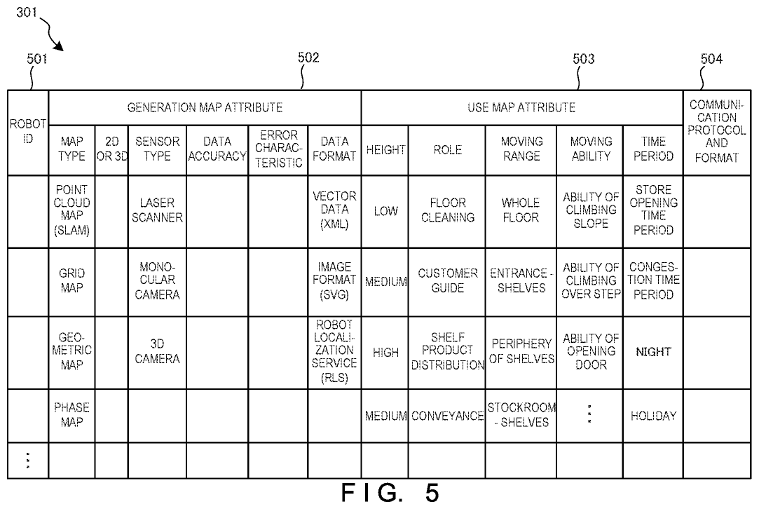

FIG. 5 is a table showing the structure of the robot database 301 according to this example embodiment. The robot database 301 is used to register information of each robot managed and controlled by the information processing apparatus 210, and process a received map and generate a specific map of each robot from the common map.

The robot database 301 stores, in association with a robot ID 501, a generation map attribute 502 associated with map generation of each robot, a use map attribute 503 associated with generation of a specific map to be used by each robot, and a communication protocol and communication format 504. The generation map attribute 502 includes a map type, data indicating whether the map is a two-dimensional map or a three-dimensional map, a sensor type used for map generation, the accuracy of the generation map, the error characteristic of the generation map, and the data format of the generation map. The use map attribute 503 includes the height as the size of the robot, the role of the robot, the moving range of the robot, the moving ability of the robot, and a time period. In the moving ability of the robot, data indicating whether the robot can overcome the obstacle conditions of various obstacles is stored as a moving ability.

Note that contents of each attribute shown in FIG. 5 are obtained by listing examples of the type, and include an array which is not associated on a row basis. Note that the differences in the generation map attribute 502 are integrated by generating a common map. Then, a specific map of each robot is generated from the common map in consideration of the differences in the use map attribute 503, and format conversion according to the differences in the generation map attribute 502 is performed, thereby transmitting the specific map to each robot. As described above, the multiple types of moving robots include robots of different attributes, and a specific map is generated in accordance with the attribute of each robot.

(Common Map Generation Table)

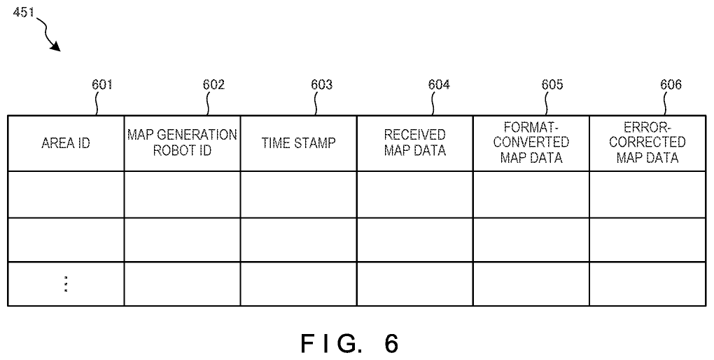

FIG. 6 is a table showing the structure of the common map generation table 451 according to this example embodiment. The common map generation table 451 is used by the common map generator 405 to generate a common map based on maps received from the respective robots.

The common map generation table 451 stores, in association with an area ID 601 included in a common map, a robot ID 602 that generates a map of each region, a time stamp 603 at which a map is generated, and received map data 604. The common map generation table 451 also stores format-converted map data 605 and error-corrected map data 606. Note that if a common map is generated from maps generated by one robot, maps of all the areas are generated by the robot of the same robot ID.

(Common Map Database)

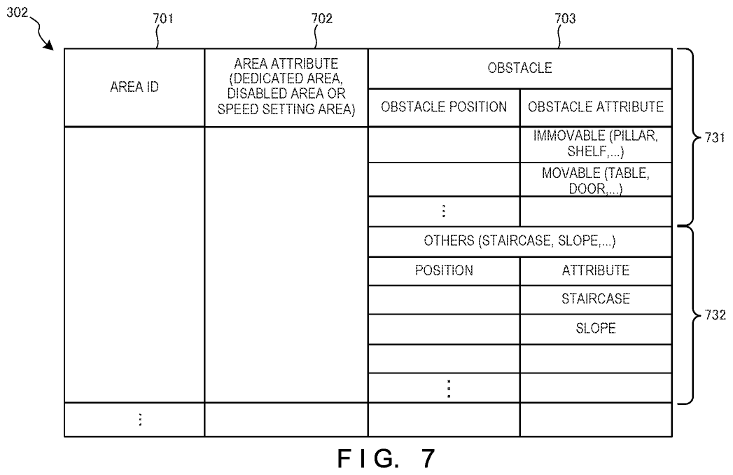

FIG. 7 is a table showing the structure of a common map database 302 according to this example embodiment. The common map database 302 holds a common map for integrally manages and controls the multiple types of robots that move based on map data of different formats, and attribute information of each element of the common map, and provides the common map and the attribute information of each element of the common map to the specific map generator 407.

The common map database 302 stores, in association with an area ID 701 indicating an area included in the common map, an area attribute 702 of each area and obstacle and others (a staircase or slope which may or may not become an obstacle depending on the robot) 703 included in each area. The obstacle and others 703 include each position and the attribute of each element. The obstacle and others 703 include information 731 as an obstacle and other information 732. As the obstacle attribute or one of other attributes, movability is stored. For example, the obstacle attribute of the information 731 stores a pillar, a shelf, a wall, and the like of an immovability attribute, and stores a desk, a door, and the like of a movability attribute. Furthermore, the movability attribute includes a temporary movability attribute and an always movability attribute.

Note that division of the area corresponds to not map areas from the respective robots but differences in area attribute in the common map. The obstacle attribute and the like shown in FIG. 7 are merely examples and the present invention is not limited to them. For example, a glass, a curtain, a net, and the like, or an elevator entrance, an escalator, and the like may be stored as attributes. Although FIG. 7 shows the example of the arrangement of one common map, the common map database 302 may store common maps of a plurality of regions (stores), and a common map may be searched for in accordance with a region (store).

(Specific Map Generation Table)

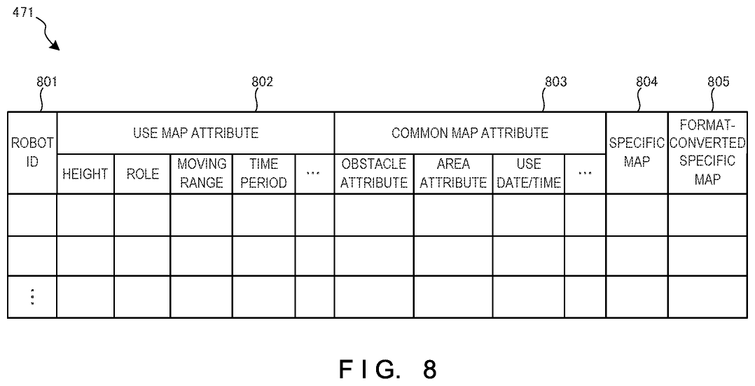

FIG. 8 is a table showing the structure of the specific map generation table 471 according to this example embodiment. The specific map generation table 471 is used by the specific map generator 407 to generate a specific map corresponding to each robot from the common map.

The specific map generation table 471 stores, in association with a robot ID 801, a use map attribute 802 (503) as the attribute of the robot for generating a specific map and a common map attribute 803 (including 702) as the attribute of the common map. The specific map generation table 471 also stores, a specific map 804 generated in consideration of the use map attribute 802 stored in the robot database 301, the common map attribute 803 stored in the common map database 302, or a combination thereof, and a format-converted specific map 805 obtained by conversion into a format corresponding to each robot using conversion information based on the generation map attribute 502 stored in the robot database 301.

Note that FIGS. 2C to 2H show some examples of generation of a specific map in consideration of the use map attribute 802 and the common map attribute 803.

<Hardware Arrangement of Information Processing Apparatus>

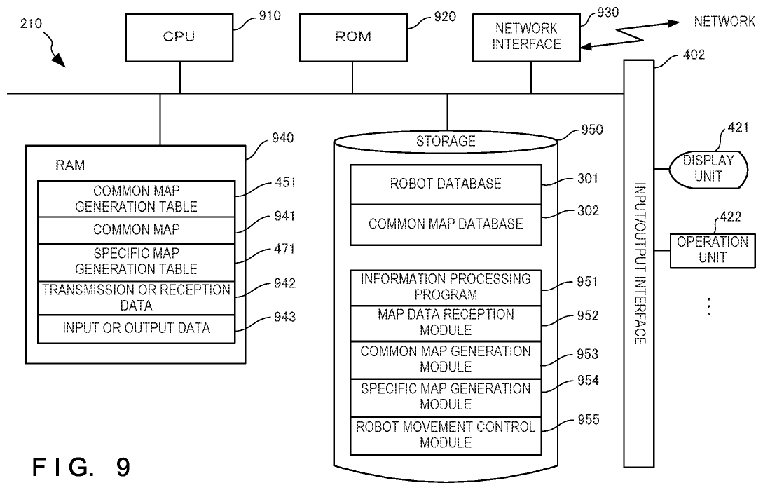

FIG. 9 is a block diagram showing the hardware arrangement of the information processing apparatus 210 according to this example embodiment.

In FIG. 9, a CPU 910 is an arithmetic control processor, and implements the functional components shown in FIG. 4 by executing a program. One CPU (Central Processing Unit) 910 or a plurality of CPUs 910 may be included. A ROM (Read Only Memory) 920 stores permanent data such as initial data and a program, and programs. A network interface 930 controls communication with each of the robot 220 and the robot control apparatus 330 via a network.

A RAM (Random Access Memory) 940 is a random access memory used as a temporary storage work area by the CPU 910. An area to store data necessary for implementation of this example embodiment is allocated to the RAM 940. The common map generation table 451 is the table shown in FIG. 6 and used to generate a common map. A common map 941 is a common map generated using the common map generation table 451 or a common map read out from the common map database 302 to generate a specific map of each robot. The specific map generation table 471 is the table shown in FIG. 8 and used to generate, from the common map, a specific map for each robot. Transmission or reception data 942 is data transmitted or received via the network interface 930. Input or output data 943 is data input or output to/from an input/output device via the input/output interface 402.

A storage 950 stores a database, various parameters, or the following data or programs necessary for implementation of this example embodiment, to be used by the CPU 910. The robot database 301 is the database shown in FIG. 5 and holding information including conversion information of each registered robot. The common map database 302 is the database shown in FIG. 7 and holding the common map and the attribute of each element of the common map.

The storage 950 stores the following programs. An information processing program 951 is a program that controls the overall information processing apparatus 210. A map data reception module 952 is a module that causes each robot to generate a map and receives the generated map. A common map generation module 953 is a module that generates a common map based on the maps received from the respective robots, and stores the common map in the common map database 302. A specific map generation module 954 is a module that reads out the common map from the common map database 302 by using, as a trigger, a request from each robot or a moving instruction to each robot, and generates a specific map for each robot in consideration of the attribute of the robot and the attribute of each element of the common map. A robot movement control module 955 is a module that manages the movement of each robot with reference to the common map and performs instruction control of the movement of each robot.

The input/output interface 402 performs interface to control data input/output to/from the input/output device. In this example embodiment, the display unit 421, the operation unit 422, and the like are connected to the input/output interface 402.

Note that programs and data which are associated with the general-purpose functions of the information processing apparatus 210 and other feasible functions are not shown in the RAM 940 or the storage 950 of FIG. 9.

<<Processing Procedure of Information Processing Apparatus>>

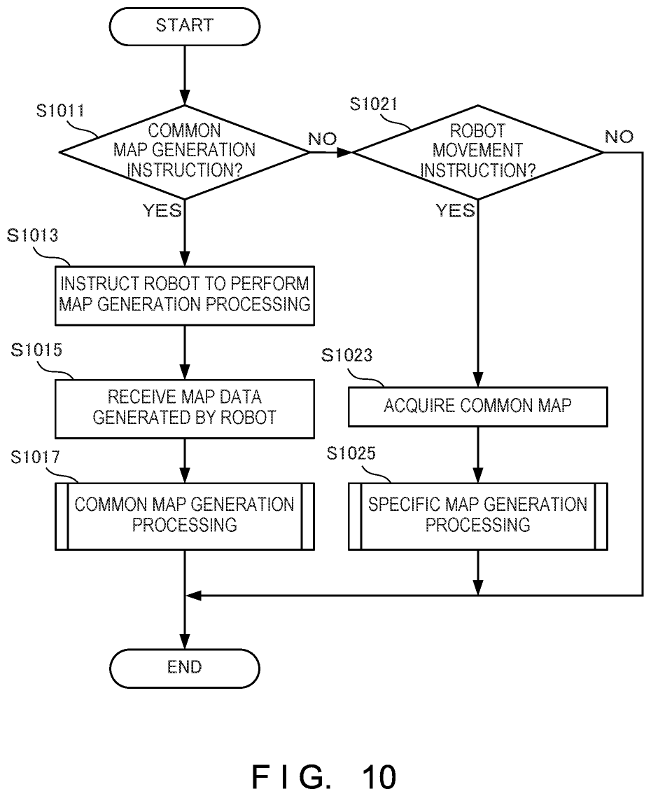

FIG. 10 is a flowchart illustrating the processing procedure of the information processing apparatus 210 according to this example embodiment. This flowchart is executed by the CPU 910 shown in FIG. 9 using the RAM 940, thereby implementing the functional components shown in FIG. 4.

In step S1011, the information processing apparatus 210 determines whether a common map generation instruction is issued. Note that the common map generation instruction is issued based on, for example, an instruction from the operation unit 422 or determination of the information processing apparatus 210. If it is determined that the common map generation instruction is issued, the information processing apparatus 210 instructs, in step S1013, a robot, that generates a map necessary for generation of a common map, to perform map generation processing. In step S1015, the information processing apparatus 210 receives map data generated by the robot. Then, in step S1017, the information processing apparatus 210 executes common map generation processing using the received map data.

On the other hand, if it is determined that no common map generation instruction is issued, the information processing apparatus 210 determines in step S1021 whether a robot movement instruction is issued. Note that although not shown in FIG. 10, a specific map request from a robot is used as a trigger for generation of a specific map. If it is determined that the robot movement instruction is issued, the information processing apparatus 210 acquires, in step S1023, the common map from the common map database 302. Then, in step S1025, the information processing apparatus 210 executes specific map generation processing.

(Common Map Generation Processing)

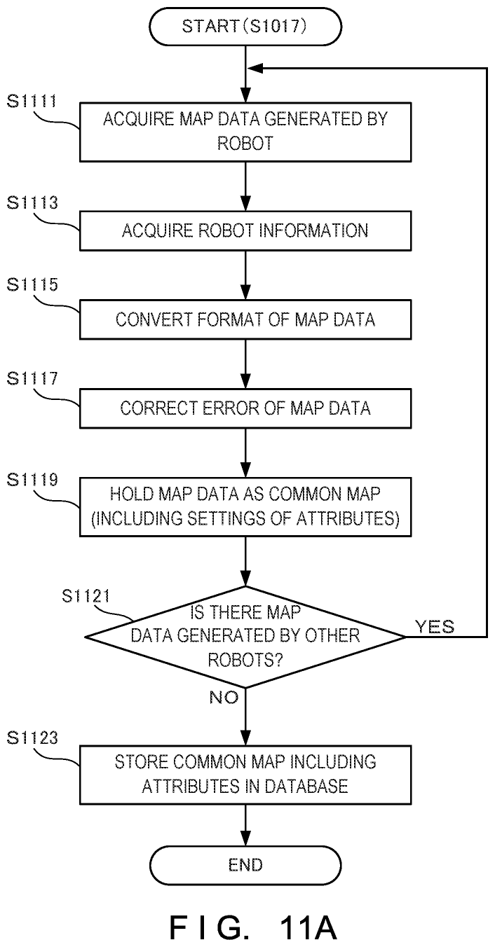

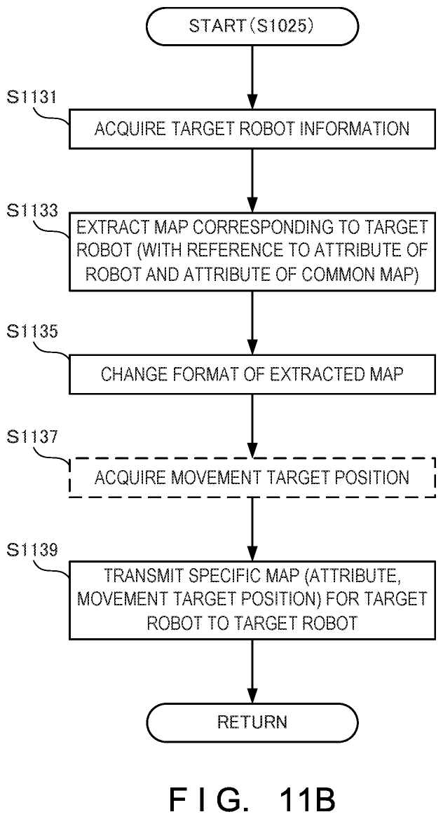

FIG. 11A is a flowchart illustrating the procedure of the common map generation processing (S1017) according to this example embodiment.

In step S1111, the information processing apparatus 210 acquires the received map data generated by the robot. In step S1113, the information processing apparatus 210 acquires, from the robot database 301, information including the attribute of the robot that has generated the map. In step S1115, the information processing apparatus 210 converts the format of the received map data into the format of a common map based on the acquired information of the robot. Note that if the format of the map data is the same as that of the common map, no format conversion is performed. In step S1117, the information processing apparatus 210 corrects an error and the like of the received map data based on the acquired information of the robot. Note that correction of the map data matches the distortion unique to the robot, the scale, and the accuracy with the common map.

In step S1119, the information processing apparatus 210 holds, as part or all of the common map including the settings of the attributes of the obstacles and the like, the map data having undergone format conversion and error correction. In step S1121, the information processing apparatus 210 determines whether there is the map data generated by other robots. If it is determined that there is the map data generated by another robot, the information processing apparatus 210 returns the process to step S1111, and processes the map data generated by the other robot to complement the common map. If it is determined that there is no map data generated by another robot, the information processing apparatus 210 stores and holds, in step S1123, the completely generated common map including the attributes in the common map database 302.

(Specific Map Generation Processing)

FIG. 11B is a flowchart illustrating the procedure of the specific map generation processing (S1025) according to this example embodiment.

In step S1131, the information processing apparatus 210 acquires, from the robot database 301, information including the attribute of the target robot which has requested a specific map or the target robot to which the movement instruction has been issued. In step S1133, the information processing apparatus 210 extracts, from the common map, a map including the attribute corresponding to the target robot. Note that extraction from the common map includes slicing at a height and selection in consideration the attribute of the robot and the attribute of each element of the common map in addition to processing of simply selecting a partial region of the common map.

In step S1135, the information processing apparatus 210 performs format conversion of the extracted map. Note that although not shown in FIG. 11B, it is desirable to generate a specific map by performing adjustment in consideration of the distortion of the robot map and the like in addition to simple format conversion.

If a specific map is generated by using the robot movement instruction as a trigger, the information processing apparatus 210 acquires a movement target position in step S1137. Note that even for the movement target position, it is desirable to convert and modify the movement target position in consideration of the tendency of position measurement or position estimation in each robot. In step S1139, the information processing apparatus 210 transmits the specific map for the target robot to the target robot by including the movement target position or the attribute, as needed.

According to this example embodiment, since a specific map for each robot is generated from the common map in consideration of the attribute of the robot and the attribute of the common map, it is possible to efficiently and more appropriately control the multiple types of robots.

For example, since, as shown in FIG. 2C, a specific map to be provided to a robot is generated in accordance with the size in the height direction of the robot, it is possible to provide map information necessary for the robot while suppressing the capacity of the specific map. Since, as shown in FIG. 2D, a specific map to be provided to a robot is generated in accordance with the role of the robot, it is possible to provide map information necessary for the robot while suppressing the capacity of the specific map, and eliminate an element unnecessary for the robot. Since, as shown in FIG. 2E, a specific map to be provided to a robot is generated in accordance with the moving range of the robot, it is possible to provide map information necessary for the robot while suppressing the capacity of the specific map, and eliminate an area where the robot does not go. Since, as shown in FIG. 2F, a specific map to be provided to a robot is generated by changing the attribute of an obstacle, it is possible to provide map information necessary for the robot while suppressing the capacity of the specific map, and correctly transmit the moving range of the robot. For example, a robot which goes in/out through a door needs to be notified of the door as a door, but a robot which does not go in/out through a door is notified of the door as a wall. When, as shown in FIG. 2G, only a notification of the moving range of each robot is sent, it is possible to provide map information necessary for the robot while suppressing the capacity of the specific map, and correctly transmit the moving range of the robot. For example, the shelf product distribution robot need only move in the periphery of the shelves, and the product conveying robot need only move along the wall in the periphery of the shelves. When, as shown in FIG. 2H, the moving range of a robot is varied depending on a time period, it is possible to provide map information necessary for the robot while suppressing the capacity of the specific map, and efficiently use the robot. For example, it is possible to execute control to use a robot-only passage at the time of congestion and to also use a passage other than the robot-only passage at the time of non-congestion, or control to prevent the robot from moving during a predetermined time period.

The present invention is not limited to the applications shown in FIGS. 2C to 2H, and various modifications are possible and are incorporated in the present invention to produce the same effects.

### Third Example Embodiment

A robot management system including an information processing apparatus according to the third example embodiment of the present invention will be described next. The robot management system including the information processing apparatus according to this example embodiment is different from that according to the above-described second example embodiment in that a common map is updated in real time along with a change at the working site of each robot. The remaining components and operations are similar to those in the second example embodiment. Hence, the same reference numerals denote similar components and operations, and a detailed description thereof will be omitted.

<<Robot Management System>>

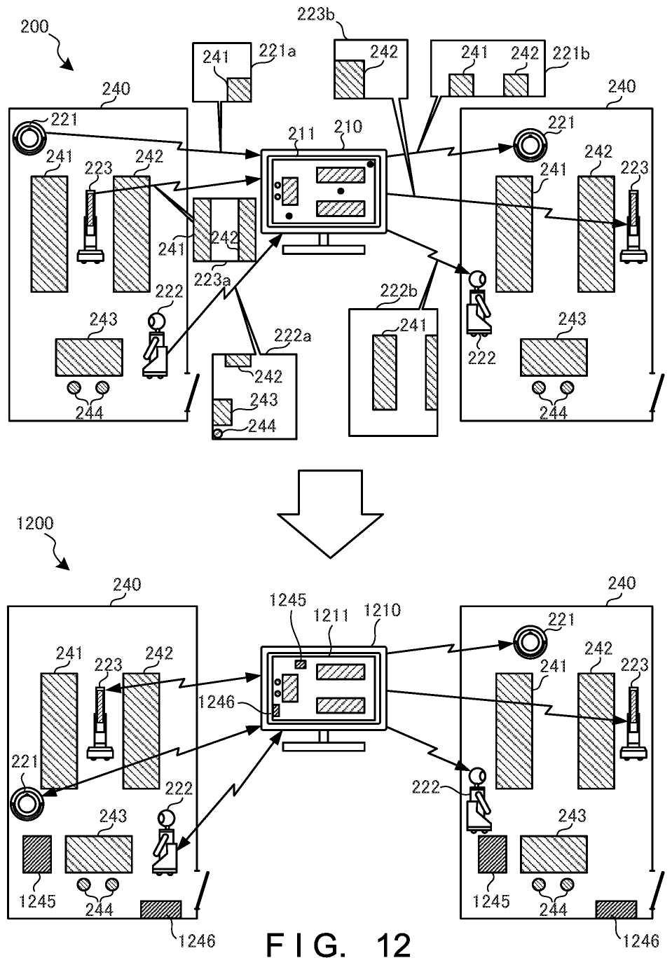

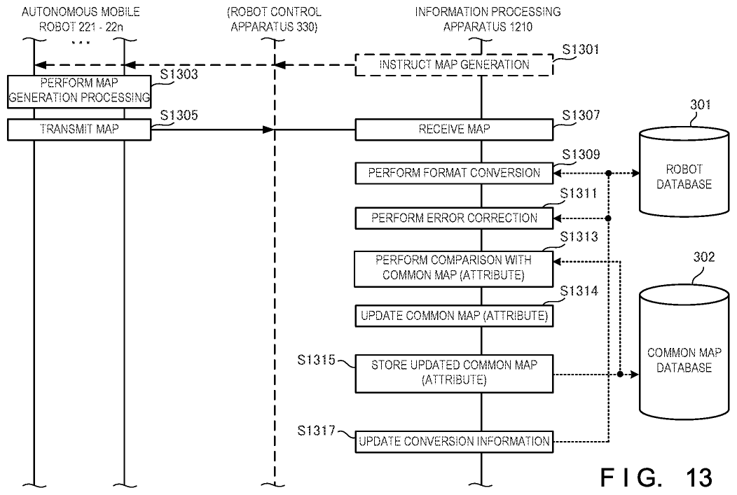

The arrangement and operation of the robot management system including the information processing apparatus according to this example embodiment will be described with reference to FIGS. 12 and 13.

(Overview)

FIG. 12 is a view showing an overview of a robot management system 1200 including an information processing apparatus 1210 according to this example embodiment. Note that in FIG. 12, the same reference numerals as in FIG. 2A denote similar components and a repetitive description thereof will be omitted.

An upper view of FIG. 12 is the same as in FIG. 2A. A lower view of FIG. 12 shows a case in which new obstacles 1245 and 1246 are added to a store 240. Assume that the obstacles 1245 and 1246 are temporal display shelves or sales tables. A cleaning robot 221 notifies the information processing apparatus 1210 of the appearance of the obstacle 1245 as a change in a map. A guide robot 222 notifies the information processing apparatus 1210 of the appearance of the obstacle 1246 as a change in the map. As a result, the information processing apparatus 1210 updates a common map, and displays a display screen 1211 of the updated common map while generating a specific map of each robot based on the updated common map.

Note that the common map can be updated to quickly respond to a change at the site by not updating an immovable element in consideration of whether each element of the common map has a movability attribute.

(Operation Procedure)

FIG. 13 is a sequence chart showing the operation procedure of the robot management system 1200 including the information processing apparatus 1210 according to this example embodiment. Note that in FIG. 13, the same step numbers as in FIG. 3 denote similar components and a repetitive description thereof will be omitted. A robot control apparatus 330 shown in FIG. 13 is an apparatus for connecting autonomous mobile robots 221 to 22n and the information processing apparatus 1210, and may be additionally provided or mounted on each robot depending on the types of the robots.

In step S1301, the information processing apparatus 1210 instructs the autonomous mobile robots 221 to 22n to perform map generation processing. Note that if one robot performs map generation processing, a map generation instruction of the entire target moving region is issued. However, if a plurality of robots perform map generation processing in cooperation with each other, the target moving region of each robot is designated. If a detailed map is required, the target moving areas of the robots may overlap each other. Note that step S1301 is optional, and is performed when, for example, periodical common map update is required. Each of the autonomous mobile robots 221 to 22n may trigger update of the common map by a notification based on a change at the site.

In step S1303, the autonomous mobile robots 221 to 22n generate maps of respective formats by respective methods. Then, in step S1305, the autonomous mobile robots 221 to 22n respectively transmit the generated maps to the information processing apparatus 1210. In step S1307, the information processing apparatus 1210 receives the maps from the autonomous mobile robots 221 to 22n.

In step S1309, the information processing apparatus 1210 converts the formats of the received map data into the format of a common map based on information registered in advance in a robot database 301. In step S1311, the information processing apparatus 1210 performs error correction of the received map data based on the information held in the robot database 301. For example, the information processing apparatus 1210 corrects the map data to maps for generation of a common map by absorbing the distortions and dimensional differences of the maps received from the robots. Then, in step S1313, the information processing apparatus 1210 compares the map received from each robot with a common map held in a common map database 302. Note that if an attribute is included, the attribute is also compared.

If there is a difference between the common map and each of the maps received from the robots, the information processing apparatus 1210 updates, in step S1314, the different portion of the common map or the attribute. In step S1315, the information processing apparatus 1210 stores and holds the updated common map in the common map database 302. In step S1317, if the error or the accuracy of the map data from each robot changes, the information processing apparatus 1210 desirably updates conversion information for converting a movement target position.

<<Functional Arrangement of Information Processing Apparatus>>

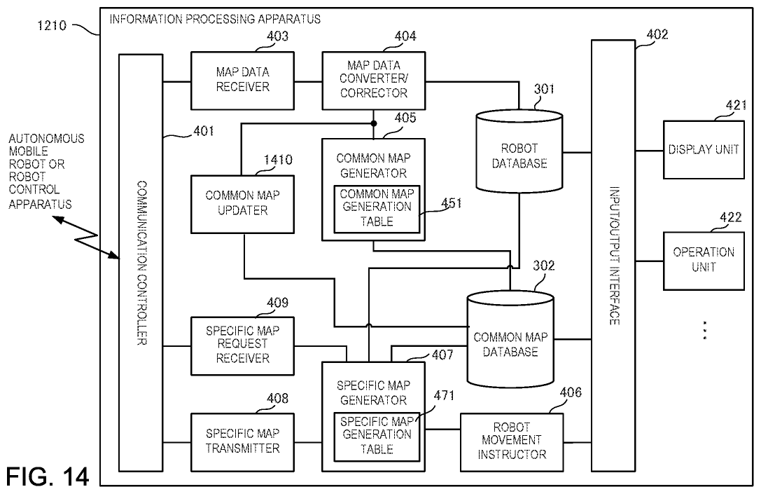

FIG. 14 is a block diagram showing the functional arrangement of the information processing apparatus 1210 according to this example embodiment. Note that in FIG. 14, the same reference numerals as in FIG. 4 denote similar components and a repetitive description thereof will be omitted.

Referring to FIG. 14, a common map updater 1410 is further provided. The common map updater 1410 compares map data having undergone conversion and correction by a map data converter and corrector 404 with the common map acquired from the common map database 302, and updates, if there is a difference, the different portion, and stores the updated common map in the common map database 302. Note that the common map updater 1410 attempts to speed up the processing by avoiding comparison of an immovable element in the common map in comparison between the common map and the map data from each robot.

Note that update of the common map is based on the map data from each robot in FIG. 14. However, the common map can be sufficiently updated based on an image or other information from each robot. A procedure in which the information processing apparatus 1210 recognizes the necessity of update of the common map based on an image or other information from each robot and causes the robot near the change position to transmit a map may be possible.

<<Processing Procedure of Information Processing Apparatus>>

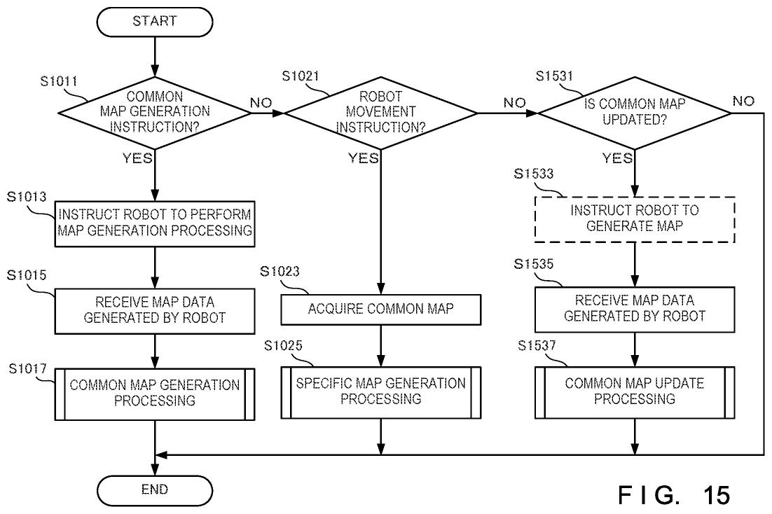

FIG. 15 is a flowchart illustrating the processing procedure of the information processing apparatus 1210 according to this example embodiment. This flowchart is executed by a CPU 910 shown in FIG. 9 using a RAM 940, thereby implementing the functional components shown in FIG. 14. Note that in FIG. 15, the same step numbers as in FIG. 10 denote similar steps and a repetitive description thereof will be omitted.

If it is determined in step S1021 that no robot movement instruction is issued, the information processing apparatus 1210 determines in step S1531 whether the common map is updated. If it is determined that the common map is updated, the information processing apparatus 1210 instructs, in step S1533, the robot near the change position at the site to generate a map, as needed.

In step S1535, the information processing apparatus 1210 receives the map data generated by the robot. Then, in step S1537, the information processing apparatus 1210 executes common map update processing.

(Common Map Update Processing)

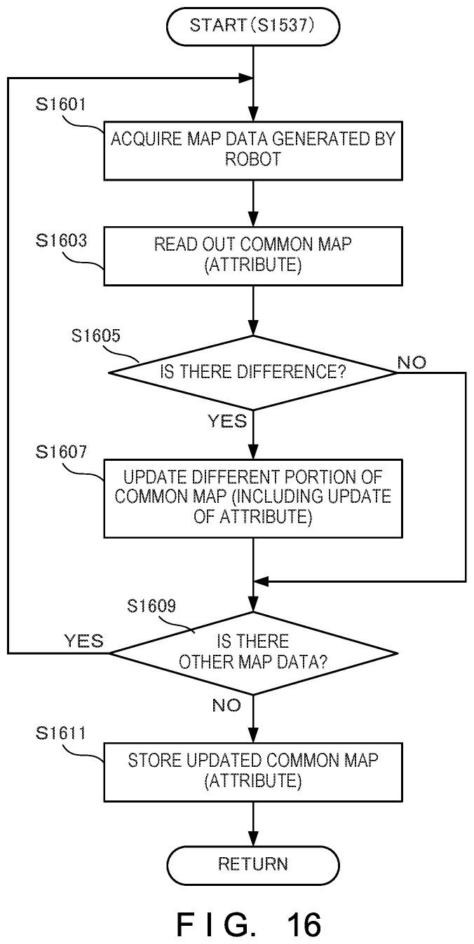

FIG. 16 is a flowchart illustrating the procedure of the common map update processing (S1537) according to this example embodiment.

In step S1601, an acquirer of the information processing apparatus 1210 acquires the map data received from the robot. In step S1603, the information processing apparatus 1210 reads out the common map from the common map database 302. In step S1605, the information processing apparatus 1210 compares the map data received from the robot with the common map, and determines whether there is a difference. If it is determined that there is a difference, the information processing apparatus 1210 updates, in step S1607, the different portion of the common map and its attribute.

In step S1609, the information processing apparatus 1210 determines whether there is other received map data. If it is determined that there is another received map data, the information processing apparatus 1210 returns the process to step S1601, and executes the common map update processing using the other map data. If it is determined that there is no other map data, the information processing apparatus 1210 stores, in step S1611, the updated common map in the common map database 302.

According to this example embodiment, since the common map is updated by the map data transmitted from the robot, it is possible to quickly respond to a change at the working site of the robot. Especially, since an element which highly probably moves is updated in the common map and an element which moves at a low probability is not updated, it is possible to quickly update the common map in real time.

### Fourth Example Embodiment

A robot management system including an information processing apparatus according to the fourth example embodiment of the present invention will be described next. The robot management system including the information processing apparatus according to this example embodiment is different from those according to the above-described second and third example embodiments in that a drone is included as a robot. The remaining components and operations are similar to those in the second or third example embodiment. Hence, the same reference numerals denote similar components and operations, and a detailed description thereof will be omitted.

<<Robot Management System>>

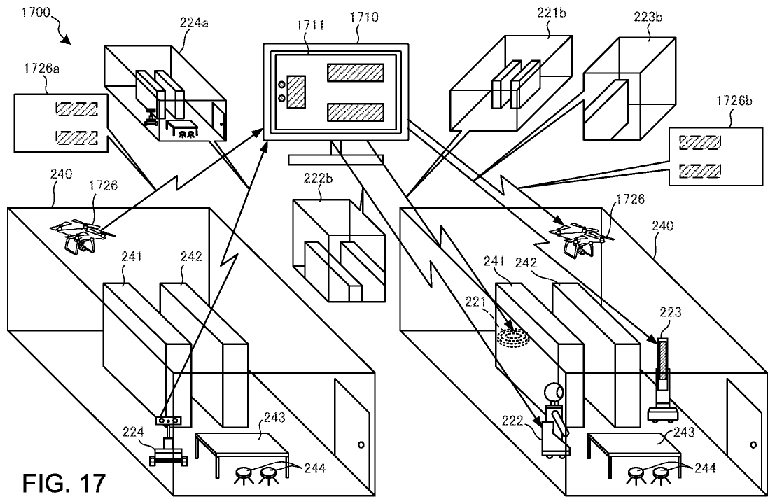

FIG. 17 is a view showing an overview of a robot management system 1700 including an information processing apparatus 1710 according to this example embodiment. Note that in FIG. 17, the same reference numerals as in FIG. 2B denote similar components and a repetitive description thereof will be omitted.

In FIG. 17, a drone 1726 is added as a map providing apparatus for generation of a common map. Map data 1726a from the drone is also transmitted to the information processing apparatus 1710, and is used to generate a common map, and the generated common map is displayed on a display screen 1711. Then, a specific map 1726b which is generated from the common map and used by the drone to move is transmitted to the drone 1726.

Note that the map data 1726a from the drone 1726 may indicate the flight range of the drone or the bird's eye view of the entire room. On the other hand, the specific map 1726b used by the drone to move need only include the flight range of the drone, and a lower layer where the drone does not fly may be set as an obstacle.

According to this example embodiment, since a common map of a wide range including a space where there are no obstacles including persons is generated to extend the working range of the robot, it is possible to more efficiently control multiple types of robots. Particularly, it is possible to improve the efficiency of a transportation service or monitoring service by a drone.

### Fifth Example Embodiment

A robot management system including an information processing apparatus according to the fifth example embodiment of the present invention will be described next. The robot management system including the information processing apparatus according to this example embodiment is different from those according to the above-described second to fourth example embodiments in that information other than information of a robot is used to generate a common map. The remaining components and operations are similar to those in each of the second to fourth example embodiments. Hence, the same reference numerals denote similar components and operations, and a detailed description thereof will be omitted.

<<Robot Management System>>

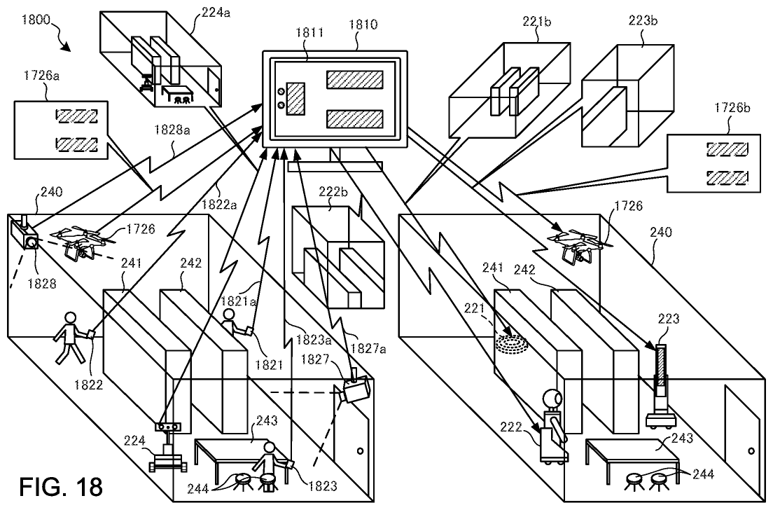

FIG. 18 is a view showing an overview of a robot management system 1800 including an information processing apparatus 1810 according to this example embodiment. Note that in FIG. 18, the same reference numerals as in FIGS. 2B and 17 denote similar components and a repetitive description thereof will be omitted.

In FIG. 18, communication terminals carried by a customer and a clerk are added as map providing apparatuses for generation of a common map. Map data (not shown) from communication terminals 1821 to 1823 and surveillance cameras 1827 and 1828 are also transmitted to the information processing apparatus 1810, and are used to generate a common map and its attribute, and the common map is displayed on a display screen 1811.

Note that each of the communication terminals 1821 to 1823 and the surveillance cameras 1827 and 1828 need not transmit the map data. For example, the information processing apparatus 1810 receives images from the communication terminals 1821 to 1823 and the surveillance cameras 1827 and 1828 and uses them to generate a common map and its attribute.

According to this example embodiment, since information other than information of a robot is used to generate a common map, it is possible to efficiently control multiple types of robots in correspondence with a change in environment of the site.

### Other Example Embodiments

Note that each of the above-described example embodiments has mainly explained an autonomous mobile robot as a robot. The present invention is not limited to this. Even if the present invention is applied to a robot whose movement is externally controlled, it is possible to obtain the same effects.

While the invention has been particularly shown and described with reference to example embodiments thereof, the invention is not limited to these example embodiments. It will be understood by those of ordinary skill in the art that various changes in form and details may be made therein without departing from the spirit and scope of the present invention as defined by the claims. A system or apparatus including any combination of the individual features included in the respective example embodiments may be incorporated in the scope of the present invention.

The present invention is applicable to a system including a plurality of devices or a single apparatus. The present invention is also applicable even when an information processing program for implementing the functions of example embodiments is supplied to the system or apparatus directly or from a remote site. Hence, the present invention also incorporates the program installed in a computer to implement the functions of the present invention by the computer, a medium storing the program, and a WWW (World Wide Web) server that causes a user to download the program. Especially, the present invention incorporates at least a non-transitory computer readable medium storing a program that causes a computer to execute processing steps included in the above-described example embodiments.

### Other Expressions of Example Embodiments

Some or all of the above-described example embodiments can also be described as in the following supplementary notes but are not limited to the followings.

(Supplementary Note 1)

There is provided an information processing apparatus comprising:

an acquirer that acquires map data generated by at least one of multiple types of robots that move based on map data in different formats indicating movable areas, respectively;

a common map generator that generates, from the acquired map data, a common map for commonly managing movements of the multiple types of robots; and

a specific map generator that generates, from the generated common map, multiple types of specific maps to be respectively used by the multiple types of robots.

(Supplementary Note 2)

There is provided the information processing apparatus according to supplementary note 1, wherein the multiple types of robots include robots with different attributes, and

said specific map generator generates the multiple types of specific maps from the generated common map in accordance with attributes of the multiple types of robots, respectively.

(Supplementary Note 3)

There is provided the information processing apparatus according to supplementary note 2, wherein the generated common map is a three-dimensional map including information in a height direction,

the multiple types of robots include robots of different sizes in a height direction, and

said specific map generator generates the multiple types of specific maps by slicing the common map at different heights corresponding to the different sizes in the height direction of the multiple types of robots.

(Supplementary Note 4)

There is provided the information processing apparatus according to supplementary note 2 or 3, wherein the multiple types of robots include robots with different roles, and

said specific map generator generates the multiple types of specific maps from the generated common map in accordance with roles of the multiple types of robots, respectively.

(Supplementary Note 5)

There is provided the information processing apparatus according to supplementary note 2, 3, or 4, wherein the multiple types of robots include robots with different moving ranges, and

said specific map generator generates the multiple types of specific maps from the generated common map in accordance with moving ranges of the multiple types of robots, respectively.

(Supplementary Note 6)

There is provided the information processing apparatus according to any one of supplementary notes 1 to 5, wherein the generated common map includes a plurality of elements with different attributes, respectively, and

said specific map generator generates the multiple types of specific maps from the generated common map in consideration of attributes of the plurality of elements, respectively.

(Supplementary Note 7)

There is provided the information processing apparatus according to supplementary note 6, wherein the generated common map includes a plurality of obstacles with different attributes, respectively, and

said specific map generator generates the multiple types of specific maps from the generated common map in consideration of attributes of the plurality of obstacles, respectively.

(Supplementary Note 8)

There is provided the information processing apparatus according to supplementary note 7, wherein the generated common map includes a plurality of obstacles different attributes, and

said specific map generator generates the multiple types of specific maps from the generated common map in consideration of attributes of the plurality of obstacles and moving abilities of the multiple types of robots, respectively.

(Supplementary Note 9)

There is provided the information processing apparatus according to supplementary note 6, 7, or 8, wherein the generated common map includes a plurality of regions with different attributes, respectively, and

said specific map generator generates the multiple types of specific maps from the generated common map in consideration of attributes of the plurality of regions, respectively.

(Supplementary Note 10)

There is provided the information processing apparatus according to supplementary note 9, wherein the generated common map includes at least one of a dedicated area where the robot moves, an area where the robot should not enter, and an area where a moving speed of the robot is limited.

(Supplementary Note 11)

There is provided the information processing apparatus according to any one of supplementary notes 1 to 10, wherein said specific map generator generates multiple types of specific maps for time periods during which one of the multiple types of robots moves, respectively.

(Supplementary Note 12)

There is provided the information processing apparatus according to any one of supplementary notes 1 to 11, wherein the generated common map includes a plurality of elements with different movabilities depending on the multiple types of robots, respectively, and

the information processing apparatus further comprises a common map updater that updates, in consideration of the different movabilities, positions of the plurality of elements included in the generated common map.

(Supplementary Note 13)

There is provided the information processing apparatus according to any one of supplementary notes 1 to 12, further comprising:

a storage that stores conversion information for converting a position on the generated common map into positions on the multiple types of specific maps; and

a movement instructor that sends movement instructions to the multiple types of robots by converting, using the conversion information, movement target positions of the multiple types of robot on the generated common map into movement target positions of the multiple types of robots on the multiple types of specific maps, respectively.

(Supplementary Note 14)

There is provided the information processing apparatus according to any one of supplementary notes 1 to 13, wherein said acquirer acquires map data within different areas respectively generated by the multiple type of robots, and

said common map generator generates the common map by connecting the map data within the different areas.

(Supplementary Note 15)

There is provided the information processing apparatus according to any one of supplementary notes 1 to 14, wherein said acquirer acquires map data in different formats respectively generated by the multiple types of robots, and

said common map generator generates the common map by converting the map data in the different formats into a common format.

(Supplementary Note 16)

There is provided an information processing method comprising:

acquiring map data generated by at least one of multiple types of robots that move based on map data in different formats indicating movable areas, respectively;

generating, from the acquired map data, a common map for commonly managing movements of the multiple types of robots; and

generating, from the generated common map, multiple types of specific maps to be respectively used by the multiple types of robots.

(Supplementary Note 17)

There is provided an information processing program for causing a computer to execute a method, comprising:

acquiring map data generated by at least one of multiple types of robots that move based on map data in different formats indicating movable areas, respectively;

generating, from the acquired map data, a common map for commonly managing movements of the multiple types of robots; and

generating, from the generated common map, multiple types of specific maps to be respectively used by the multiple types of robots.

(Supplementary Note 18)

There is provided a robot management system comprising:

multiple types of robots;

an acquirer that acquires map data generated by at least one of the multiple types of robots that move based on map data in different formats indicating movable areas, respectively;

a common map generator that generates, from the acquired map data, a common map for commonly managing movements of the multiple types of robots;

a specific map generator that generates, from the generated common map, multiple types of specific maps to be respectively used by the multiple types of robots, respectively; and

a movement instructor that sends movement instructions to the multiple types of robots by converting, using conversion information for converting a position on the generated common map into positions on the multiple specific maps, movement target positions of the multiple types of robots on the generated common map into movement target positions of the multiple types of robots on the multiple types of specific maps, respectively.

(Supplementary Note 19)

There is provided a robot management method comprising:

acquiring map data generated by at least one of multiple types of robots that move based on map data in different formats indicating movable areas, respectively;

generating, from the acquired map data, a common map for commonly managing movements of the multiple types of robots;

generating, from the generated common map, multiple types of specific maps to be respectively used by the multiple types of robots; and

sending movement instructions to the multiple types of robots by converting, using conversion information for converting a position on the generated common map into positions on the multiple types of specific map, movement target positions of the multiple types of robots on the generated common map into movement target positions of the multiple types of robots on the multiple types of specific maps, respectively.

1. An information processing apparatus comprising:
an acquirer that acquires map data generated by at least one of multiple types of robots that move based on map data in different formats indicating movable areas, respectively;
a common map generator that generates, from the acquired map data, a common map for commonly managing movements of the multiple types of robots; and
a specific map generator that generates, from the generated common map, multiple types of specific maps to be respectively used by the multiple types of robots.

2. The information processing apparatus according to claim 1, wherein the multiple types of robots include robots with different attributes, and
said specific map generator generates the multiple types of specific maps from the generated common map in accordance with attributes of the multiple types of robots, respectively.

3. The information processing apparatus according to claim 2, wherein the generated common map is a three-dimensional map including information in a height direction,
the multiple types of robots include robots of different sizes in a height direction, and
said specific map generator generates the multiple types of specific maps by slicing the common map at different heights corresponding to the different sizes in the height direction of the multiple types of robots.

4. The information processing apparatus according to claim 2, wherein the multiple types of robots include robots with different roles, and
said specific map generator generates the multiple types of specific maps from the generated common map in accordance with roles of the multiple types of robots, respectively.

5. The information processing apparatus according to claim 2, wherein the multiple types of robots include robots with different moving ranges, and
said specific map generator generates the multiple types of specific maps from the generated common map in accordance with moving ranges of the multiple types of robots, respectively.

6. The information processing apparatus according to claim 1, wherein the generated common map includes a plurality of elements with different attributes, respectively, and
said specific map generator generates the multiple types of specific maps from the generated common map in consideration of attributes of the plurality of elements, respectively.

7. The information processing apparatus according to claim 6, wherein the generated common map includes a plurality of obstacles with different attributes, respectively, and
said specific map generator generates the multiple types of specific maps from the generated common map in consideration of attributes of the plurality of obstacles, respectively.

8. The information processing apparatus according to claim 7, wherein the generated common map includes a plurality of obstacles different attributes, and
said specific map generator generates the multiple types of specific maps from the generated common map in consideration of attributes of the plurality of obstacles and moving abilities of the multiple types of robots, respectively.

9. The information processing apparatus according to claim 6, wherein the generated common map includes a plurality of regions with different attributes, respectively, and
said specific map generator generates the multiple types of specific maps from the generated common map in consideration of attributes of the plurality of regions, respectively.

10. The information processing apparatus according to claim 9, wherein the generated common map includes at least one of a dedicated area where the robot moves, an area where the robot should not enter, and an area where a moving speed of the robot is limited.

11. The information processing apparatus according to claim 1, wherein said specific map generator generates multiple types of specific maps for time periods during which one of the multiple types of robots moves, respectively.

12. The information processing apparatus according to claim 1, wherein the generated common map includes a plurality of elements with different movabilities depending on the multiple types of robots, respectively, and
the information processing apparatus further comprises a common map updater that updates, in consideration of the different movabilities, positions of the plurality of elements included in the generated common map.

13. The information processing apparatus according to claim 1, further comprising:
a storage that stores conversion information for converting a position on the generated common map into positions on the multiple types of specific maps; and
a movement instructor that sends movement instructions to the multiple types of robots by converting, using the conversion information, movement target positions of the multiple types of robot on the generated common map into movement target positions of the multiple types of robots on the multiple types of specific maps, respectively.

14. The information processing apparatus according to claim 1, wherein said acquirer acquires map data within different areas respectively generated by the multiple type of robots, and
said common map generator generates the common map by connecting the map data within the different areas.

15. The information processing apparatus according to claim 1, wherein said acquirer acquires map data in different formats respectively generated by the multiple types of robots, and
said common map generator generates the common map by converting the map data in the different formats into a common format.

16. An information processing method comprising:
acquiring map data generated by at least one of multiple types of robots that move based on map data in different formats indicating movable areas, respectively;
generating, from the acquired map data, a common map for commonly managing movements of the multiple types of robots; and
generating, from the generated common map, multiple types of specific maps to be respectively used by the multiple types of robots.

17. An non-transitory computer-readable storage medium storing an information processing program for causing a computer to execute a method, comprising:
acquiring map data generated by at least one of multiple types of robots that move based on map data in different formats indicating movable areas, respectively;
generating, from the acquired map data, a common map for commonly managing movements of the multiple types of robots; and
generating, from the generated common map, multiple types of specific maps to be respectively used by the multiple types of robots.

18. (canceled)

19. (canceled)

20. The information processing apparatus according to claim 4, wherein the multiple types of robots include robots with different moving ranges, and
said specific map generator generates the multiple types of specific maps from the generated common map in accordance with moving ranges of the multiple types of robots, respectively.

21. The information processing apparatus according to claim 2, wherein the generated common map includes a plurality of elements with different attributes, respectively, and
said specific map generator generates the multiple types of specific maps from the generated common map in consideration of attributes of the plurality of elements, respectively.

22. The information processing apparatus according to claim 6, wherein the generated common map includes a plurality of elements with different movabilities depending on the multiple types of robots, respectively, and
the information processing apparatus further comprises a common map updater that updates, in consideration of the different movabilities, positions of the plurality of elements included in the generated common map.
